(19) United States
(12) Patent Application Publication
(10) Pub. No.: US 2002/0095303 A1
(43) Pub. Date: Jul. 18, 2002

(54) System and method for selecting a credit card processor

(76) Inventors: Takao Asayama, Sunnyvale, CA (US); Kazuma Higashida, San Jose, CA (US)

Correspondence Address: SQUIRE, SANDERS & DEMPSEY L.L.P, 600 HANSEN WAY, PALO ALTO, CA, 94304-1043, US

(21) Appl. No.: 09/904,978

(22) Filed: Jul. 12, 2001

Related U.S. Application Data
(60) Provisional application No. 60/218,976, filed on Jul. 17, 2000.

(51) Int. Cl. G06F 17/60

(52) U.S. Cl. 705/1

(57) ABSTRACT

A system for selecting a credit card processor is communicatively coupled to at least two processors and a merchant. The system comprises a processing engine capable to receive an order from the merchant, select a processor from the at least two processors based on a plurality of criteria, send information associated with the order to a selected processor for processing, receiving a response from the selected processor, and sending the response to the merchant.

This application claims priority to and incorporates by reference provisional patent application Ser. No. 60/218,976, entitled “BILLING ASSISTANT,” filed on Jul. 17, 2000, by inventors Kazuma Higashida and Takao Asayama.

### TECHNICAL FIELD

This invention relates generally to credit card processing, and more particularly, but not exclusively, provides techniques for selecting a credit card processor to process a credit card transaction.

### BACKGROUND

In more and more markets, consumers are frequently using credit and/or debit cards, in place of cash and/or checks, to make purchases. Further, when a consumer makes an online purchase, generally the sole technique to pay for the purchase is to use a credit or debit card. For a merchant to accept credit or debit cards for purchases, whether online, via telephone, or in person, the merchant must have an association with a credit card processor. Credit card processors execute credit card transactions for purchases and usually charge the merchant a fee as a function of many variables, including total purchase price. Generally, the processing fee varies among processors, with some processors charging a percentage of the purchase price with or without a maximum or minimum fee while other processors charging a flat rate. Accordingly, the transaction fee for an identical purchase may vary among processors.

However, a merchant generally only has an association with a single credit card processor, limiting the merchant to use that credit card processor even if the merchant could get a reduced transaction fee from a different processor for some transactions. In addition, even if a merchant has associations with multiple processors, it can be extremely complicated to select a processor having the most inexpensive transaction fee for each particular transaction.

Accordingly, an improved technique for selecting a credit card processor for a transaction as a function of multiple variables may be highly desirable.

### SUMMARY

The present invention provides a system for selecting a credit card processor as a function of multiple variables, including transaction fees, speed of processor in performing transaction, processor availability, and other variables. Note that the term “credit card” as used herein refers to credit cards, debit cards, ATM cards, and any other similar mechanism. The system is coupled to at least one merchant and at least two processors. The system comprises a page rendering engine, a processing engine, and a database. The page rendering engine renders a payment web page for display on a merchant's website for initiating a consumer credit or debit card transaction. The processing engine receives credit card data and associated information from the payment web page or other device and selects one of multiple processors for processing the transaction based on multiple variables. The processing engine also translates the received credit card data and associated information into a form readable by the selected processor. The processing engine also translates and response received from the selected merchant into a form understandable by the merchant and/or consumer. After the transaction is complete, the processing engine may store data regarding the transaction in the database. In another embodiment of the invention, the processing engine may also perform fraud detection and/or fraud screening operations.

The present invention further provides a method for selecting a credit card processor for completing a credit card purchase transaction. The method comprises: receiving credit card purchase transaction data, selecting a credit card processor for completing the transaction, translating the transaction data into a form understandable by the selected processor, sending the translated data to the selected processor, receiving a response from the processor, translating the response, forwarding the translated response to the merchant, and recording the transaction in a database. The method may also perform fraud screening and/or fraud detection.

The system and method may advantageously select a credit card processor to perform a credit or debit card transaction as a function of several variables.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a billing assistant server communicatively coupled to a merchant and a plurality of processors;

FIG. 2 is a block diagram illustrating the billing assistant server of FIG. 1 in accordance with an embodiment of the present invention;

FIG. 3 is a block diagram illustrating contents of memory the billing assistant server;

FIG. 4 is a block diagram illustrating contents of a processing engine in memory of the billing assistant server; and

FIG. 5 is a flowchart diagram of a method of selecting a credit card processor.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

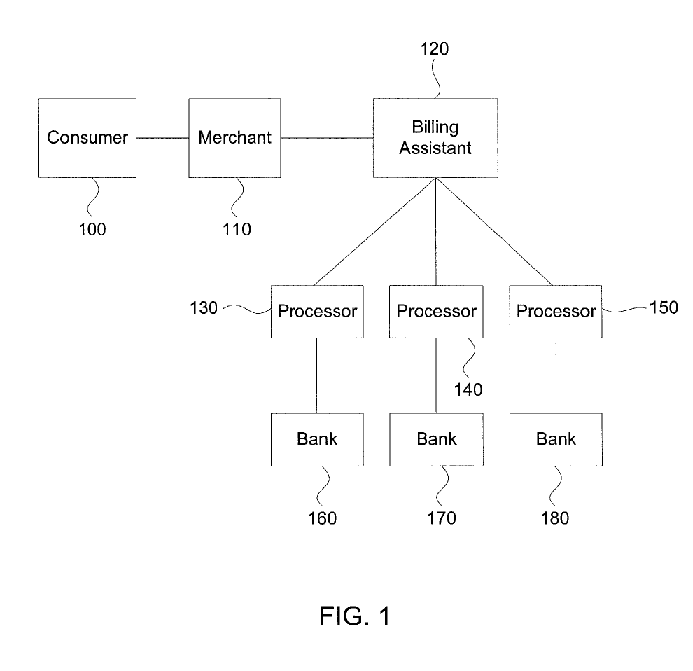

FIG. 1 is a diagram illustrating a billing assistant server 120 communicatively coupled to a merchant 110 and a plurality of processors 130, 140, and 150. Merchant 110 may be a web merchant and is communicatively coupled to a consumer 100, who wants to initiate a credit card purchase transaction. Alternatively, merchant 110 may be a store having a physical location and consumer 100 may be located within the store. Processors 130, 140, and 150 are communicatively coupled respectively to banks 160, 170, and 180. In alternative embodiments, processors 130, 140, and 150 may each be communicatively coupled to multiple different banks or each processor may be communicatively coupled to identical banks or a subset of identical banks. In another embodiment, billing assistant server 120 may be coupled to multiple merchants and/or additional processors. There is no limit to the number of processors or merchants that billing assistant server 120 may be communicatively coupled to.

There is also no restriction on geographic location of billing assistant server 120, merchant 110, processors 130, 140, and 150, and banks 160, 170, and 180. For example, server 120 may be located in the U.S. while merchant 110 may be located in Japan. Further, processors 130 and 140 may be located in the U.S. while processor 150 may be located in Canada. Similarly, banks 160, 170 and 180 may each be located in a different country, may all be located in the same country, or two of banks 160, 170, and 180 may be located in the same country. In addition, banks 160, 170, and 180 may be multi-currency capable providing multi-currency credit card processing capability. This capability enables merchant 110 to charge consumer 100 in the native currency of merchant 110, thereby avoid foreign currency exchange risks.

Billing assistant server 120 may be communicatively coupled to merchant 110 via a network, such as the Internet, or server 120 may be communicatively coupled to merchant 110 via other techniques, such as a direct cable connection, etc. Similarly, server 120 may be communicatively coupled to processors 130, 140, and 150 via a network, such as the Internet, or other techniques. Further, server 120 may be communicatively coupled to processors 130, 140, and 150 each via different techniques. Alternatively, two of processors 130, 140, and 150 may be communicatively coupled to server 120 via the same technique.

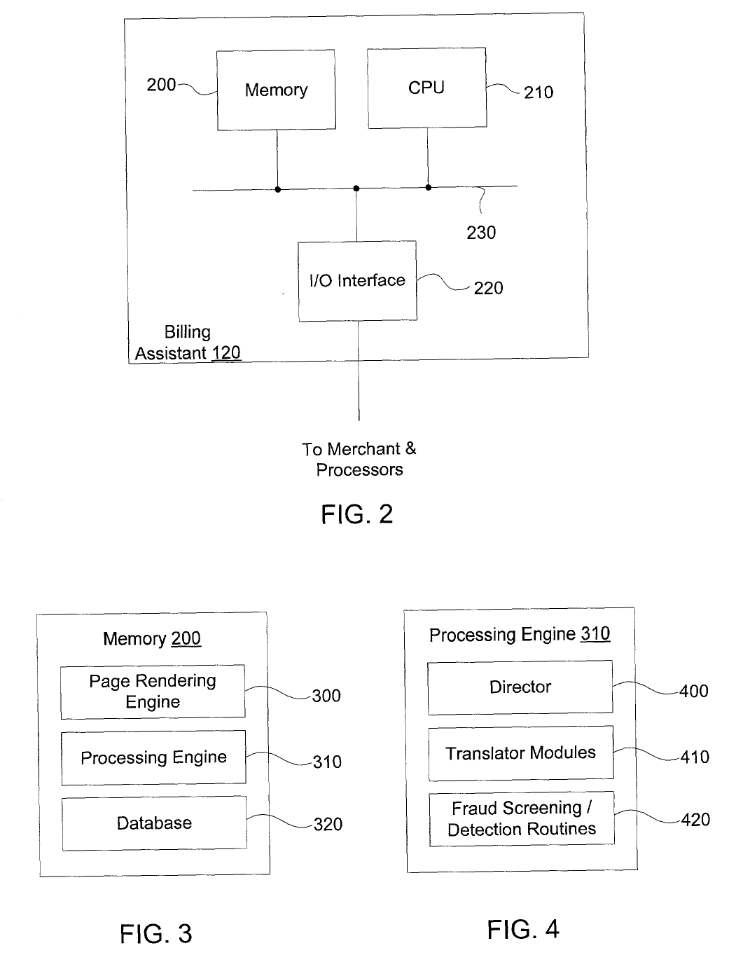

FIG. 2 is a block diagram illustrating billing assistant server 120 in accordance with an embodiment of the present invention. The server 120 includes a central processing unit (“CPU”) 210, such as an Intel Pentium® microprocessor or a Motorola Power PC® microprocessor, communicatively coupled to a system bus 230. The computer system 100 further includes a memory device 200, such as a magnetic disk, Random-Access Memory (RAM), or other memory device or combination of memory devices, and Input/Output (“I/O”) interface 220, each communicatively coupled to the system bus 230. Server 120 may also optionally include an input device (not shown), such as a keyboard or mouse, and an output device (not shown) such as a cathode ray tube display, each communicatively coupled to the system bus 230. The I/O interface 220 is communicatively coupled to merchant 110 and processors 160, 170, and 180 via a network such as the wide-area network commonly referred to as the Internet. In an alternative embodiment, I/O interface 220 may be communicatively coupled to merchant 110 and processors 10, 170 and 180 via other techniques. One skilled in the art will recognize that, although the memory device 200 is illustrated as an integral unit, the memory device 200 can be a distributed unit. Contents of memory 200 will be discussed in conjunction with FIG. 3 and FIG. 4.

One skilled in the art will recognize that the server 120 may also include additional devices, such as network connections, additional memory, additional processors, LANs, input/output lines for transferring information across a hardware channel, the Internet or an intranet, etc. Further, it will be appreciated that the term “memory” herein is intended to cover all data storage media whether permanent or temporary.

FIG. 3 is a block diagram illustrating contents of memory 200 according to an embodiment of the invention. Memory 200 comprises an optional page rendering engine 300, a processing engine 310, and a database 320. It will be appreciated that, although some elements (including steps) are labeled herein as optional, other elements not labeled optional may still be optional. Page rendering engine 300 renders a payment page on a merchant 110 website if merchant 110 is a web merchant. The payment page allows the consumer 100 to enter credit or debit card information as well as shipping information and any other information required for to transact a credit or debit card purchase.

Processing engine 310 receives, from the rendered payment page, credit or debit card information, as well all other information necessary for transacting a credit or debit card purchase. In alternative embodiments, processing engine 310 may receive the above-mentioned information via manual entry, via a merchant 110 credit card terminal, or other technique. The processing engine 310 then chooses a processor (processor 130, 140 or 150) and translates the credit or debit card information into a format understandable by the chosen processor.

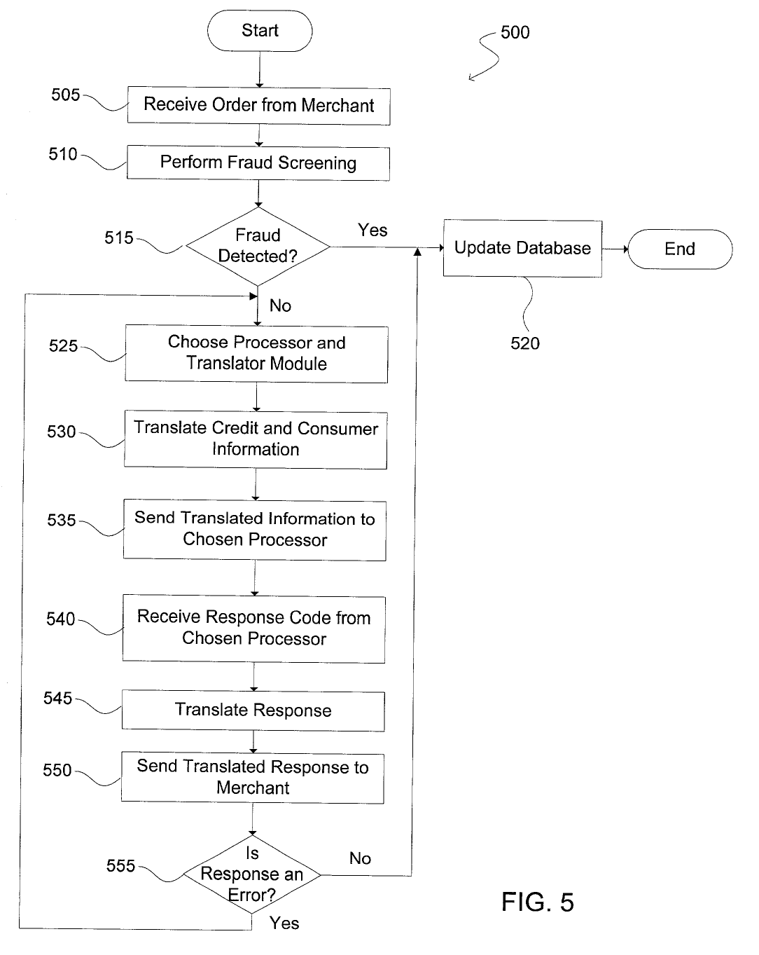

After the chosen processor processes the transaction, the processing engine 310 receives a confirmation and/or other response from the chosen processor. The processing engine 310 can then translate the confirmation or response to a form understandable by the merchant 110 and forwards the translated confirmation or response to the merchant 110. The processing engine 310 may then also store details of the transaction in database 320. The processing engine 310 may also perform other functions, such as fraud screening and fraud detection. Processing engine 310 will be discussed in further detail in conjunction with FIG. 4 and FIG. 5.

Database 320 stores records of all past transactions, including incomplete and attempted transactions, for all consumers. Database 320 may also include feedback from merchant 110 for consumers. In an embodiment of the invention, database 320 may be indexed by consumer, enabling records from multiple merchants for a single consumer to be stored in a single record.

Memory 200 may also include a purchase history search engine (not shown) that allows a consumer to search database 320 for his or her purchase history from multiple merchants for multiple orders. The search engine may also allow for package tracking via compatible transportation companies.

FIG. 4 is a block diagram illustrating contents of processing engine 310 according to an embodiment of the invention. Processing engine 310 includes a director 400, translator modules 410 and fraud screening/detection routines 420. Director 400 is an executable module in processing engine 310 that directs all the functions of processing engine 310 and may use translator modules 410 and fraud screen/detection routines 420. For example, director 400 may translate credit or debit card information using translator modules 410. Further, director 400 may perform fraud screening using fraud screening/detection modules 420.

Translator modules 410 are a set of modules that are processor specific, i.e., in an embodiment of the invention, translator modules 420 may include three modules—one for each of processors 130, 140, and 150. Translator modules 420 contain instructions for translating data received from processors 130, 140 and 150 to a form understandable by merchant 110 and for translating data to send to processors 130, 140 and 150 in a form understandable by the processors 130, 140 or 150.

Fraud screening/detection modules 420 include instructions for performing fraud screening and fraud detection that may be implemented by director 400. Examples of possible fraud screening/detection techniques include:

screening based on geographic location; i.e., some locations may be more prone to credit card fraud than others;

screening based on IP address; i.e., some IP addresses may be associated with past fraudulent transactions;

screening based on issuing bank; i.e., an offshore bank may be a front for credit card fraud;

screening based on validity of phone numbers; i.e., an invalid phone number may indicate fraud; and

screening based on validity of zip or postal codes; i.e., a zip or postal code that does not match up with an address may indicate fraud.

In addition, fraud screening/detection modules 420 may contain data mining instructions for use with database 320, i.e., fraud screening/detection routines 420 may be used to examining a consumer's transactions at a plurality of merchants to detect possible fraud. Examples of characteristics that fraud screening/detection modules 420 may screen for using data mining include:

past failed attempts of purchasing;

past purchase history and frequency, i.e., multiple purchases in a short amount of time may indicate a stolen credit card;

past credit charge back history and frequency, i.e., frequent charge backs may indicate fraudulent use of a credit card;

feedback from merchants;

use of multiple cards over a short time span;

frequent change of billing address; and

online behavior, such as revisiting or resubmitting forms.

Fraud screening/detection modules 420 may also screen for fraud by questioning a consumer to identify the issuing bank of his or her card. If the consumer cannot identify the issuing bank as printed on the card, then the consumer may be attempting to make a fraudulent purchase.

FIG. 5 is a flowchart diagram of a method 500 of selecting a credit card processor. In one embodiment of the invention, processing engine 310 may implement method 500. In method 500, first, an order is received (505) from a merchant. The order can be received via a merchant's website, via credit card terminal, or other devices. In one embodiment, the order includes the consumer's name, address, credit card number, credit card expiration date, purchase amount, merchant name, shipping address, and item(s) purchased. Fraud screening and/or detection (510) may then be optionally performed. In an embodiment of the invention, the fraud screen/detection can be performed by processing engine 310 using fraud screening/detection routines 420. If fraud is detected or suspected (515) then a consumer record in a database, such as database 320, may be updated (520) to reflect that fraud was detected. The method 500 then ends.

If fraud is not detected (515) or suspected, then a processor and associated translation module is chosen (525) as a function of the following criteria:

Processor Criteria

Processing volume limit;

Minimum purchase price;

Maximum purchase price;

Minimum monthly volume of transactions;

Maximum monthly volume of transactions;

Card type availability (VISA, MC, AMEX, etc.);

Currency availability (Yen, U.S. Dollar, etc.);

Pre-authorization capability;

Partial refund capability;

Length of pre-authorization expiration;

Processing capability (transactions /minute);

Network conditions

Network availability;

Load to server 120;

Latency of response from processor;

Unexpected or unreasonable error from processor;

Consumer Criteria

Region of consumer;

Region of consumer's issuing bank;

Merchant Criteria

Nature of service or products (high risk, low risk, hard goods, soft good, etc.);

Strategic Criteria

Processing fee for transaction; and

Cash flow of processor (payment cycle).

The function for selecting a processor may use a linear weighted score technique (i.e., for each processor:

$${Score}_{processor} = {\sum }_{n = 1}^{m} {W}_{n} * {C}_{n} ,$$

wherein m is the number of criteria defined for each processor, Cₙ is the measured criteria score for each criteria, and Wₙ is the weight assigned for each criteria) or any other decision making technique or combination of techniques using the above-mentioned criteria and/or other criteria.

After a processor and associated translator module is chosen (525), credit, consumer information and other associated transaction data is translated (530). The translated data is then sent (535) to the chosen processor. A response is then received (540) from the chosen processor and translated (545). The translated response is then sent (550) to the merchant, such as merchant 110 in one embodiment. If the received response is an error (555) then the above-identified method repeats with a new processor to be chosen (525). If the received response is not an error (555) then a database, such as database 320, is updated to indicate a successful transaction for the consumer and to include associated transaction data. The method 500 then ends.

The foregoing description of the illustrated embodiments of the present invention is by way of example only, and other variations and modifications of the above-described embodiments and methods are possible in light of the foregoing teaching. For example, processing engine 310 may use an exponential weighted score technique for selecting a processor

$$( i . e . , {Score}_{processor} = {\sum }_{n = 1}^{m} {C}_{n} * {2}^{( {W}_{n} - 1 )} ) .$$

Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving an order from a merchant, the order including credit card payment information;
selecting a processor to process payment for the order based on a plurality of criteria;
sending the information to the selected processor;
receiving a response from the selected processor; and
sending the response to the merchant.

2. The method of claim 1, wherein the credit card payment information includes:
a merchant's name;
a consumer's name, billing address, credit card number, credit card expiration date; and
a purchase price for the order.

3. The method of claim 1, wherein the plurality of criteria include processor criteria, network conditions, consumer criteria, merchant criteria, and strategic criteria.

4. The method of claim 1, further comprising performing fraud screening before selecting a processor.

5. The method of claim 1, further comprising recording details of the order in a database.

6. The method of claim 1, further comprising rendering an order page on a website of the merchant for accepting orders from a consumer.

7. A machine-readable medium having stored thereon instructions to:
receive an order from a merchant, the order including credit card payment information;
select a processor to process payment for the order based on a plurality of criteria;
send the information to the selected processor;
receive a response from the selected processor; and
send the response to the merchant.

8. The machine-readable medium of claim 7, wherein the credit card payment information includes:
a merchant's name;
a consumer's name, billing address, credit card number, credit card expiration date; and
a purchase price for the order.

9. The machine-readable medium of claim 7, wherein the plurality of criteria include processor criteria, network conditions, consumer criteria, merchant criteria, and strategic criteria.

10. The machine-readable medium of claim 7, further comprising an instruction to perform fraud screening before selecting a processor.

11. The machine-readable medium of claim 7, further comprising an instruction to record details of the order in a database.

12. The machine-readable medium of claim 7, further comprising an instruction to render an order page on a website of the merchant for accepting orders from a consumer.

13. A system, comprising:
means for receiving an order from a merchant, the order including credit card payment information;
means for selecting a processor to process payment for the order based on a plurality of criteria;
means for sending the information to the selected processor;
means for receiving a response from the selected processor; and
means for sending the response to the merchant.

14. A method, comprising:
receiving an order from a merchant, the order including credit card payment information;
selecting a processor to process payment for the order based on a plurality of criteria;
translating the information into a form understandable by the selected processor;
sending the translated information to the selected processor;
receiving a response from the selected processor;
translating the response from the selected processor; and
sending the translated response to the merchant.

15. The method of claim 14, wherein the credit card payment information includes:
a merchant's name;
a consumer's name, billing address, credit card number, credit card expiration date; and
a purchase price for the order.

16. The method of claim 14, wherein the plurality of criteria include processor criteria, network conditions, consumer criteria, merchant criteria, and strategic criteria.

17. The method of claim 14, further comprising performing fraud screening before selecting a processor.

18. The method of claim 14, further comprising recording details of the order in a database.

19. The method of claim 14, further comprising rendering an order page on a website of the merchant for accepting orders from a consumer.

20. An apparatus, communicatively coupled to a merchant and at least two processors, comprising:
a processing engine capable to receive an order from the merchant, select a processor from the at least two processors based on a plurality of criteria, send information associated with the order to a selected processor for processing, receiving a response from the selected processor, and sending the response to the merchant.

21. The apparatus of claim 20, wherein the information associated with the order includes:
the merchant's name;
a consumer's name, billing address, credit card number, credit card expiration date; and
a purchase price for the order.

22. The apparatus of claim 20, wherein the plurality of criteria include processor criteria, network conditions, consumer criteria, merchant criteria, and strategic criteria.

23. The apparatus of claim 20, wherein the processing engine is further capable to perform fraud screening.

24. The apparatus of claim 20, further comprising a database and the processing engine is further capable of recording details of the order in the database.

25. The apparatus of claim 20, further comprising a page rendering engine capable of rendering an order page on a website of the merchant for accepting orders from a consumer.
